(19) United States
(12) Patent Application Publication
(10) Pub. No.: US 2010/0246621 A1
(43) Pub. Date: Sep. 30, 2010

(54) LIGHT SOURCE CONTROL APPARATUS AND LIGHT SOURCE APPARATUS

(75) Inventor: Hiroshi Kuzukami, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/704,575

(22) Filed: Feb. 12, 2010

(30) Foreign Application Priority Data
Mar. 26, 2009 (JP) 2009-077079

(51) Int. Cl. H01S 3/10

(52) U.S. Cl. 372/38.02

(57) ABSTRACT

A light source control apparatus includes a laser having a wavelength that varies depending on temperature; a wavelength monitor that monitors the wavelength of light output from the laser; a temperature controller that controls the temperature of the laser based on an output of the wavelength monitor; a temperature monitor that monitors the temperature of the laser; and a control manager that stops control by the temperature controller if a variation amount per unit time of the temperature monitored by the temperature monitor exceeds a threshold value.

### CROSS REFERENCE TO RELATED APPLICATIONS

This application is based upon and claims the benefit of priority of the prior Japanese Patent Application No. 2009-077079, filed on Mar. 26, 2009, the entire contents of which are incorporated herein by reference.

### FIELD

The embodiments discussed herein are related to a light source control apparatus and a light source apparatus.

### BACKGROUND

Accompanying larger capacities of optical communications, optical communication systems employing wavelength division multiplexing schemes have been built. Such systems enable a single optical fiber to transmit optical signals of different wavelengths and further enable transmission capacity to be increased as compared to communications through a single wavelength.

To stably operate a WDM optical communication system over a long period of time, the wavelength of the optical signal output from the light source apparatus must be stabilized. Therefore, a distributed feedback (DFB) laser capable of outputting light having a stable wavelength is used as a light source in the light source apparatus of a WDM optical communication system. Lasers such as a DFB laser output light of an intensity that corresponds to an injected current.

Since the wavelength output by a laser such as a DFB laser is temperature dependent (see FIG. 4), the wavelength output by the laser may be adjusted by controlling laser temperature (see, e.g., Japanese Laid-Open Patent Publication Nos. 2001-313613 and H7-86694). For example, a laser is disposed on a thermo-electrical cooler (TEC) such as a peltier device and a drive current injected to TEC is adjusted to control the laser temperature.

The wavelength output by the laser is stabilized by controlling the laser temperature through feedback control. The feedback control includes automatic thermal control (ATC) that controls laser temperature such that the monitored laser temperature becomes a target temperature, and automatic frequency control (AFC) that controls the laser temperature such that the monitored laser wavelength becomes a target wavelength.

Under ATC, a thermistor (TH) disposed near the laser monitors laser temperature and the current injected to the TE is adjusted such that the monitored temperature becomes a target temperature monitor value. On the other hand, under AFC, a wavelength filter and a photo diode (PD) monitor the wavelength output by a laser and the current injected to TEC is adjusted such that the monitored temperature becomes a wavelength monitor target value.

Although a stable wavelength is acquired at startup of the apparatus, if the wavelength output by the laser is stabilized under ATC, the sensitivity of TH to the temperature varies with age (see FIG. 5). As a result, the wavelength output by the laser controlled by ATC also varies with age. Therefore, ATC is unable to stabilize the wavelength output by the laser over a long period of time.

On the other hand, if the wavelength output by the laser is stabilized by AFC, the wavelength filter characteristic varies less with age and a stable wavelength may be acquired over a long period time. However, since the transmission characteristic of the wavelength filter indicates a characteristic in which the rise and fall (increase and decrease) are repeated in response to changes in the wavelength, a required slope is selected by a separate unit to correlate the output wavelengths with the monitor values one-to-one.

Actual light source apparatuses often use ATC and AFC in parallel. For example, the laser temperature is controlled by ATC at the start and, after a required slope of the wavelength filter is selected and the output wavelength comes closer to a target value, the laser temperature control is switched to AFC. If the laser output wavelength varies, an alarm is issued and the user is notified, thereby enabling various measures to be taken, such as safe termination of the system or apparatus replacement.

However, with the above conventional technology, if a characteristic of a wavelength monitor value for the wavelength output by the laser changes, the actual wavelength output by the laser varies due to the operation of AFC. The characteristic of the wavelength monitor value for the wavelength output by the laser varies due to changes in the angle of incidence of the output laser light on a wavelength filter or changes in angle and intensity of light other than the output laser light, such as leaked light and reflected light, incident on the wavelength filter in the apparatus.

When leaked light and reflected light within the apparatus are incident on the wavelength filter, the characteristic of the wavelength monitor value for the wavelength output by the laser may become non-monotonic (see, e.g., FIGS. 7 and 8). Therefore, direction of the change of the wavelength monitor value is no longer correlated one-to-one with the actual change direction of the laser and the wavelength output by the laser may abruptly vary due to malfunction of AFC. The wavelength variation in this case is proportional to a response time constant of AFC and the wavelength variation of a few nm may occur in a few seconds.

If the wavelength output by the laser varies, a failure such as interference between channels occurs in the WDM optical communication system. If the characteristic of the wavelength monitor value for the wavelength output by the laser becomes non-monotonic, since the wavelength output by the laser is not correctly reflected by the wavelength monitor value, it is problematic that an alarm may be issued when no wavelength variation actually occurs or no alarm may be issued when a variation in wavelength occurs.

### SUMMARY

According to an aspect of an embodiment, a light source control apparatus includes a laser having a wavelength that varies depending on temperature; a wavelength monitor that monitors the wavelength of light output from the laser; a temperature controller that controls the temperature of the laser based on an output of the wavelength monitor; a temperature monitor that monitors the temperature of the laser; and a control manager that stops control by the temperature controller if a variation amount per unit time of the temperature monitored by the temperature monitor exceeds a threshold value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a light source apparatus according to a first embodiment.

FIG. 2 is a block diagram of an example of the light source apparatus depicted in FIG. 1.

FIG. 3 is a flowchart of an example of the operation of the light source apparatus depicted in FIG. 2.

FIG. 4 is a graph of the characteristic of output wavelength with respect to the temperature of a DFB laser.

FIG. 5 is a graph of the characteristic of the temperature monitor value with respect to the temperature of the DFB laser.

FIG. 6 is a graph of the characteristic of the wavelength monitor value with respect to the wavelength output by the DFB laser.

FIG. 7 depicts light leaked to a wavelength filter.

FIG. 8 is a graph of the characteristic of the wavelength monitor value when leak light is present.

FIG. 9 is a graph of the combined characteristic depicted in FIG. 8.

FIG. 10 is an enlarged graph of a portion of the combined characteristic depicted in FIG. 9.

FIG. 11 is a graph of the characteristic when the combined characteristic depicted in FIG. 9 varies as a result of aging.

FIG. 12 is a block diagram of a light source apparatus according to a second embodiment.

FIG. 13 is a block diagram of an example of the light source apparatus depicted in FIG. 12.

FIG. 14 is a flowchart of an example of the operation of the light source apparatus depicted in FIG. 13.

FIG. 15 is a graph of switchover from AFC to ATC.

### DESCRIPTION OF EMBODIMENTS

Preferred embodiments of the present invention will be explained with reference to the accompanying drawings. A light source control apparatus and a light source apparatus monitor laser temperature while performing AFC of a laser and stop AFC if the laser temperature varies considerably. Therefore, abrupt variations in the laser wavelength are prevented even when a monitor wavelength characteristic for an actual laser wavelength changes.

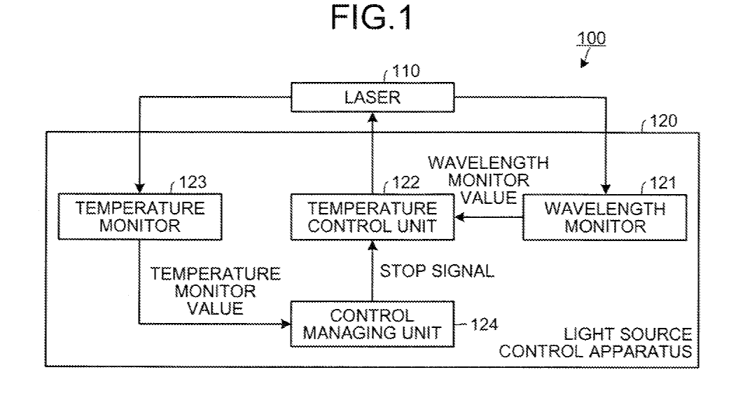

FIG. 1 is a block diagram of a light source apparatus according to a first embodiment. As depicted in FIG. 1, a light source apparatus 100 according to the first embodiment includes a laser 110 and a light source control device 120. The laser 110 is a laser that outputs light having a wavelength corresponding to the temperature of the laser 110. The laser 110 is a DFB laser, for example.

The light source control device 120 controls the laser 110 such that the wavelength output by the laser 110 becomes a target wavelength. For example, the light source control device 120 includes a wavelength monitor 121, a temperature control unit (temperature controller) 122, a temperature monitor 123, and a control managing unit (control manager) 124. The wavelength monitor 121 is a wavelength monitor unit that monitors the wavelength of light output from the laser 110. The wavelength monitor 121 outputs to the temperature control unit 122, a wavelength monitor value indicative of the monitored wavelength.

The temperature control unit 122 performs constant-monitor-wavelength control (AFC) that controls the temperature of the laser 100 such that the wavelength monitor value output from the wavelength monitor 121 is kept constant. The temperature control unit 122 is made up of a peltier device provided on the laser 110 and a control circuit thereof, for example. The temperature control unit 122 stops AFC when the control managing unit 124 outputs a stop signal.

The temperature monitor 123 is a temperature monitor unit that monitors the temperature of the laser 110. The temperature monitor 123 outputs to the control managing unit 124, a temperature monitor value indicative of the monitored temperature. The temperature monitor 123 is a thermistor provided in the vicinity of the laser 110. If a variation amount per unit time of the temperature monitor value output from the temperature monitor 123 exceeds a threshold value, the control managing unit 124 outputs to the temperature control unit 122, a stop signal to indicate that AFC is to be stopped.

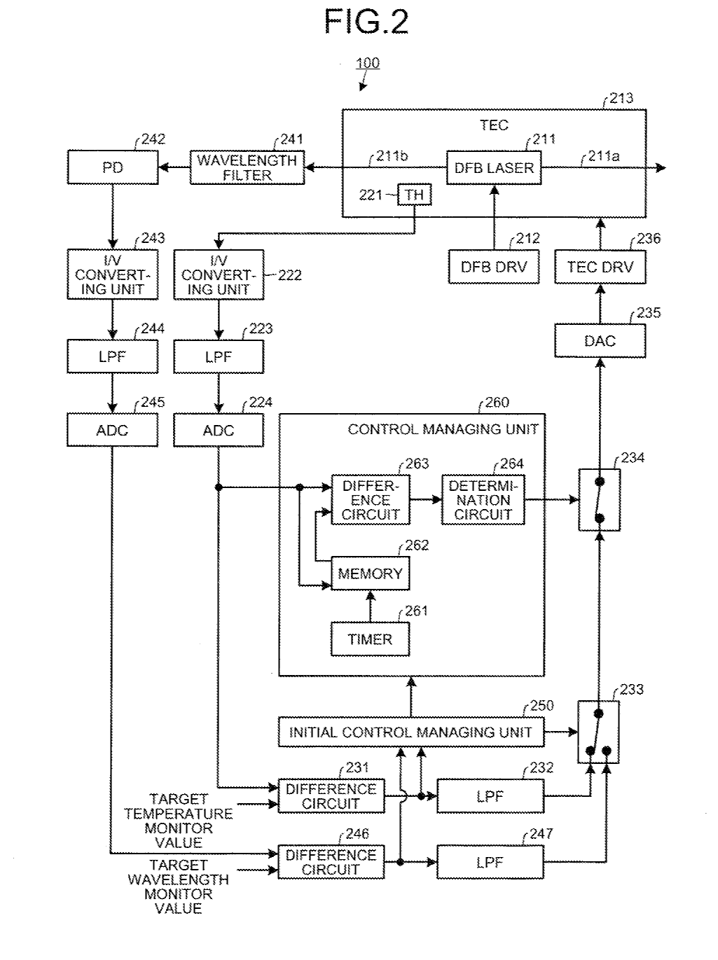

FIG. 2 is a block diagram of an example of the light source apparatus depicted in FIG. 1. The light source apparatus 100 (see FIG. 1) includes a DFB laser 211, a DFB driving unit 212, a TEC 213, a thermistor 221, I/V converting units 222, 243, low-pass filters 223, 232, 244, 247, a analog/digital converters 224, 245, difference circuits 231, 246, switches 233, 234, an digital/analogue converter 235, a TEC driving unit 236, a wavelength filter 241, a light-receiving unit 242, an initial control managing unit 250, and a control managing unit 260.

The DFB laser 211 has a configuration corresponding to the laser 110 depicted in FIG. 1. The DFB laser 211 outputs a front light 211a and a back light 211b having intensities corresponding to the drive current injected from the DFB driving unit 212 (DFB DRV). The front light 211a and the back light 211b of the DFB laser 211 vary depending on the temperature of the DFB laser 211. The front light 211a of the DFB laser 211 is output externally and the back light 211b of the DFB laser 211 is output to the wavelength filter 241.

The TEC 213 is a thermoelectric cooling device having a temperature that varies according to the drive current injected from the TEC driving unit 236. The DFB laser 211 is provided on the TEC 213 and the temperature of the DFB laser 211 becomes a temperature corresponding to the temperature of the TEC 213. Thus, the temperature of the DFB laser is controllable by the drive current injected into the TEC 213.

The thermistor 221 (TH), the I/V converting units 222, the low-pass filter 223 (LPF), and the analog/digital converter 224 (ADC) make up a configuration corresponding to the temperature monitor 123 depicted in FIG. 1. The thermistor 221 is provided in the vicinity of the DFB laser 211 of the TEC 213 and outputs to the I/V converting unit 222, a current indicative of the temperature of the DFB laser 211.

The I/V converting unit 222 performs current/voltage conversion of the current output from the thermistor 221 and outputs the current/voltage-converted current to the low-pass filter 223. The low-pass filter 223 extracts and outputs a low-frequency component of the current output from the I/V converting unit 222 to the analog/digital converter 224. The analog/digital converter 224 performs analog/digital conversion of the current output from the low-pass filter 223 and outputs to the control managing unit 260 and the difference circuit 231, the analog/digital-converted signal as the temperature monitor value (see FIG. 1) indicative of the temperature of the DFB laser 211.

The difference circuit 231, the low-pass filter 232 (LPF), the switch 233, the switch 234, the digital/analogue converter 235 (DAC), the TEC driving unit 236 (TEC DRV), the difference circuit 246, and the low-pass filter 247 (LPF) make up a configuration corresponding to the temperature control unit 122 depicted in FIG. 1.

The difference circuit 231 receives input of the temperature monitor value output from the analog/digital converter 224 and a preset target temperature monitor value.

The difference circuit 231 outputs to the low-pass filter 232 and the initial control managing unit 250, the difference between the input temperature monitor value and target temperature monitor value, as a temperature error. The low-pass filter 232 extracts and outputs to the switch 233, a low-frequency component of the temperature error output from the difference circuit 231.

The switch 233 receives input of the temperature error output from the low-pass filter 232 and a wavelength error (described later) output from the low-pass filter 247. The switch 233 outputs the input temperature error or wavelength error to the switch 234. The switch 233, under the control of the initial control managing unit 250, switches between outputting the temperature error and the wavelength error.

The switch 234 outputs to the digital/analogue converter 235, the temperature error (or wavelength error) output from the switch 233. The switch 234 blocks the temperature error (or wavelength error) output from the switch 233 when the control managing unit 260 outputs a stop signal. The digital/analogue converter 235 performs digital/analog conversion of the signal output from the switch 234 and outputs the digital/analog-converted current to the TEC driving unit 236. The TEC driving unit 236 injects to the TEC 213, a drive current corresponding to the current output from the digital/analogue converter 235.

The wavelength filter 241, the light-receiving unit 242 (PD), the I/V converting unit 243, the low-pass filter 234 (LPF), and the analog/digital converter 245 (ADC) make up a configuration corresponding to the wavelength monitor 121 depicted in FIG. 1. The wavelength filter 241 transmits the back light 211b of the DFB laser 211 at different transmission rates for each wavelength component. The light-receiving unit 242 receives the light transmitted through the wavelength filter 241 and outputs to the I/V converting unit 243, a current indicative of the intensity of the received light.

The I/V converting unit 243 performs current/voltage conversion of the current output from the light-receiving unit 242 and outputs to the low-pass filter 244, the current/voltage-converted current. The low-pass filter 244 extracts and outputs to the analog/digital converter 245, a low-frequency component of the current output from the I/V converting unit 243. The analog/digital converter 245 performs analog/digital conversion of the current output from the low-pass filter 244. The analog/digital converter 245 outputs to the difference circuit 246, the analog/digital-converted signal as the wavelength monitor value (see FIG. 1) indicative of the wavelength output by the DFB laser 211.

The difference circuit 246 receives input of the wavelength monitor value output from the analog/digital converter 245 and a preset wavelength monitor target value. The difference circuit 246 outputs to the low-pass filter 247 and the initial control managing unit 250, the difference between the input wavelength monitor value and wavelength monitor target value as a wavelength error. The low-pass filter 247 extracts and outputs to the switch 233, a low-frequency component of the wavelength error output from the difference circuit 246.

The initial control managing unit 250 manages the control at the startup of the light source apparatus 100. The initial control managing unit 250 controls the switch 233 at the startup of the light source apparatus 100 such that, among the temperature error and the wavelength error input to the switch 233, the temperature error is output to the switch 234. This starts the temperature control of the DFB laser 211 by ATC.

When the temperature error output from the difference circuit 231 becomes equal to or less than a predetermined value, the initial control managing unit 250 controls the switch 233 output such that, among the temperature error and the wavelength error input to the switch 233, the wavelength error is output to the switch 234. This causes the temperature control of the DFB laser 211 to switch from ATC to AFC.

As described, the initial control managing unit 250 performs the temperature control of the DFB laser 211 by ATC at the startup of the light source apparatus 100 and switches ATC to AFC when the temperature of the DFB 211 comes close to the target temperature. This enables AFC to start from a state where the wavelength output by the DFB laser 211 has come close to the target wavelength.

Thus, malfunction of AFC is prevented and the wavelength output by the DFB laser 211 is stably controlled. The initial control managing unit 250 switches ATC to AFC and outputs a trigger signal to the control managing unit 260. If the initial control managing unit 250 outputs the trigger signal, the control managing unit 260 starts the following operations.

The control managing unit 260 has a configuration corresponding to the control managing unit 124 depicted in FIG. 1. For example, the control managing unit 260 includes a timer 261, a memory 262, a difference circuit 263, and a determination circuit 264. The timer 261 periodically outputs a trigger signal to the memory 262. The memory 262 sequentially updates and stores the temperature monitor value output from the analog/digital converter 224. When the timer 261 outputs the trigger signal, the memory 262 outputs to the difference circuit 263, the temperature monitor value stored at that time.

The difference circuit 263 receives input of the temperature monitor value output from the analog/digital converter 224 and the temperature monitor value output from the memory 262. The difference circuit 263 outputs to the determination circuit 264, the difference between the temperature monitor value output from the analog/digital converter 224 and the temperature monitor value output from the memory 262 as a temperature variation value. The determination circuit 264 determines whether the temperature variation value output from the difference circuit 263 exceeds a predetermined threshold value.

If the temperature variation value exceeds the threshold value, the determination circuit 264 outputs a stop signal to the switch 234. This blocks the wavelength error output to the digital/analogue converter 235. Therefore, the drive current injected to the TEC 213 by the TEC driving unit 236 becomes fixed and AFC is stopped. The determination circuit 264 may stop AFC and issue an alarm externally. This enables a user to be notified of the termination of AFC.

The cycle of the trigger signal output to the memory 262 by the timer 261 may be set to about 0.5 to 5 seconds. If the cycle of the trigger signal output by the timer 261 is too long, the wavelength variation of the DFB laser 211 is detected quickly since the temperature variation monitor cycle becomes longer. If the cycle of the trigger signal output by the timer 261 is too short, the wavelength variation of the DFB laser 211 becomes undetectable since the temperature monitor value does not substantially change in one cycle.

In the communication system of the WDM mode, if the specified wavelength accuracy is less than ±25 μm, the threshold value of the temperature variation value of the determination circuit 264 may be set to about 0.05 to 0.1 degrees C. When the threshold value of the temperature variation value is set to about 0.05 to 0.1 degrees C., since the temperature variation value exceeds the threshold value if a wavelength variation of 5 to 10 μm occurs, AFC is stopped when the wavelength accuracy requirement of the communication system of the WDM mode is no longer satisfied.

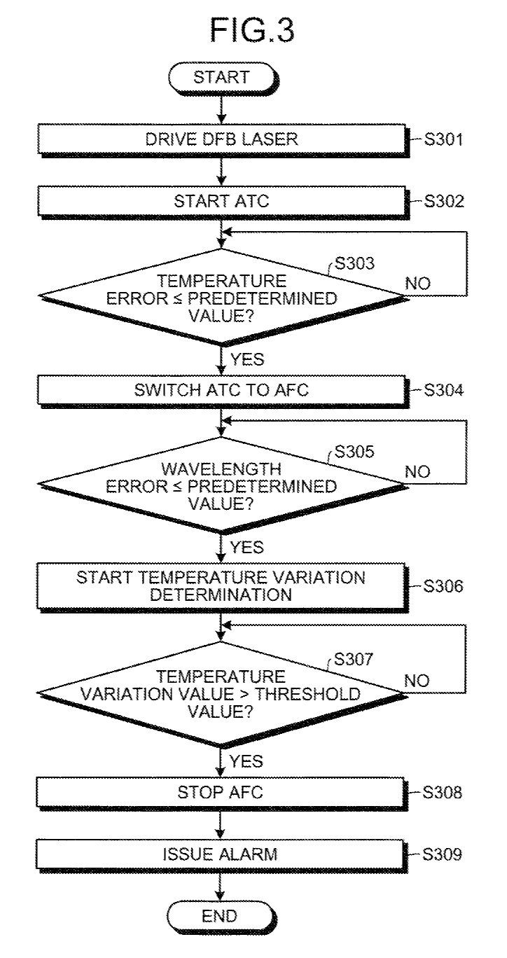

FIG. 3 is a flowchart of an example of the operation of the light source apparatus depicted in FIG. 2. It is assumed that the switch 234 is set to output the signal from the switch 233 to the digital/analogue converter 235 in the initial state. First, the DFB driving unit 212 injects the drive current to the DFB laser 211 to drive the DFB laser 211 (step S301).

The initial control managing unit 250 starts ATC by controlling the switch 233 such that the temperature error output from the low-pass filter 232 to the switch 233 is output to the switch 234 (step S302). The initial control managing unit 250 determines whether the temperature error output from the difference circuit 231 is equal to or less than the predetermined value (step S303) and waits until the temperature error becomes equal to or less than the predetermined value (step S303: NO).

If the temperature error becomes equal to or less than the predetermined value at step S303 (step S303: YES), the initial control managing unit 250 switches the temperature control of the DFB laser 211 from ATC to AFC by controlling the switch 233 such that the wavelength error output from the low-pass filter 247 to the switch 233 is output to the switch 234 (step S304).

The initial control managing unit 250 determines whether the wavelength error output from the difference circuit 246 is at most, the predetermined value (step S305) and waits until the wavelength error becomes equal to or less than the predetermined value (step S305: NO). When the wavelength error becomes equal to or less than the predetermined value (step S305: YES), the initial control managing unit 250 outputs the trigger signal to the control managing unit 260 to start the temperature variation determination by the control managing unit 260 (step S306).

The determination circuit 264 of the control managing unit 260 determines whether the temperature variation value output from the difference circuit 263 exceeds the threshold value (step S307) and waits until the temperature variation value exceeds the threshold value (step S307: NO). When the temperature variation value exceeds the threshold value (step S307: YES), the determination circuit 264 outputs the stop signal to the switch 234 to stop AFC (step S308). The determination circuit 264 issues an alarm externally (step S309), and a series of processing is terminated.

The control managing unit 260 may shut down the light source apparatus 100 (of the control managing unit 260) when a given period of time elapses after the temperature variation value exceeds the threshold value at step S307. This prevents a failure from occurring in another channel of the WDM communication system when the wavelength output by the DFB laser 211 varies, even if the alarm issued at step S309 goes unnoticed by the user.

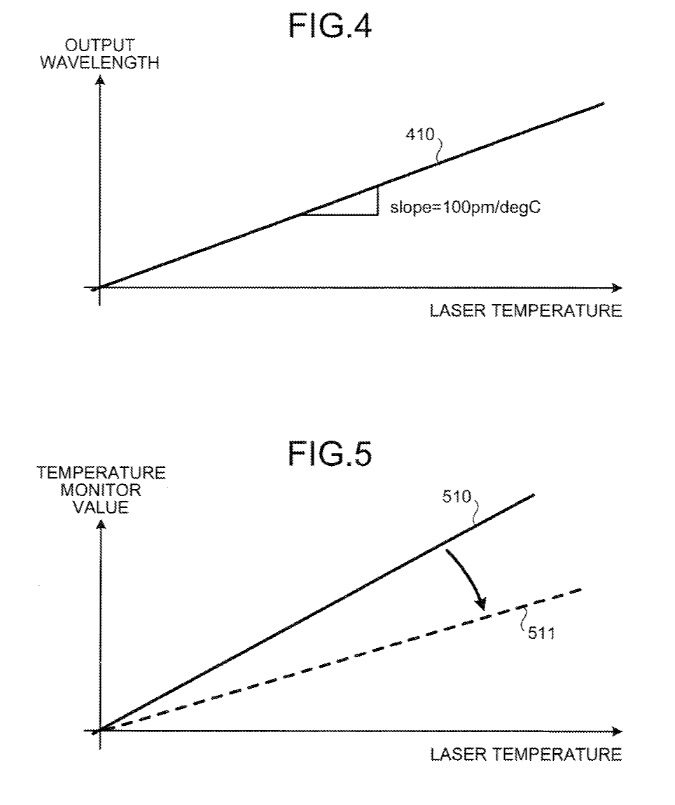

FIG. 4 is a graph of the characteristic of the output wavelength with respect to the temperature of the DFB laser. In FIG. 4, the horizontal axis (laser temperature) indicates the actual temperature of the DFB laser 211. The vertical axis indicates the actual wavelength output by the DFB laser 211. As indicated by a characteristic 410, the actual wavelength output by the DFB laser 211 increases proportionally to the actual temperature of the DFB laser 211.

Therefore, the actual wavelength output by the DFB laser 211 is kept constant by using the TEC 213 to control the temperature of the DFB laser 211 at constant level. In this case, each time the temperature of the DFB laser 211 increases by 1 degree C., the wavelength output by the DFB laser 211 increases by 100 μm (slope=100 μm/degree C.).

FIG. 5 is a graph of the characteristic of the temperature monitor value with respect to the temperature of the DFB laser. In FIG. 5, the horizontal axis (laser temperature) indicates the actual temperature of the DFB laser 211. The vertical axis indicates the temperature monitor value output from the analog/digital converter 224. As indicated by a characteristic 510, the temperature monitor value increases proportionally to the actual temperature of the DFB laser 211.

Thus, the variation in the actual temperature of the DFB laser 211 is monitored through the temperature monitor value. However, due to deterioration with age, as indicated by a dotted-line 511, the variation amount of the temperature monitor value may vary relative to the variation amount of the temperature of the DFB laser 211. The deterioration with age is caused, for example, by deterioration of an adhesive agent fixing the thermistor 221 to the TEC 213.

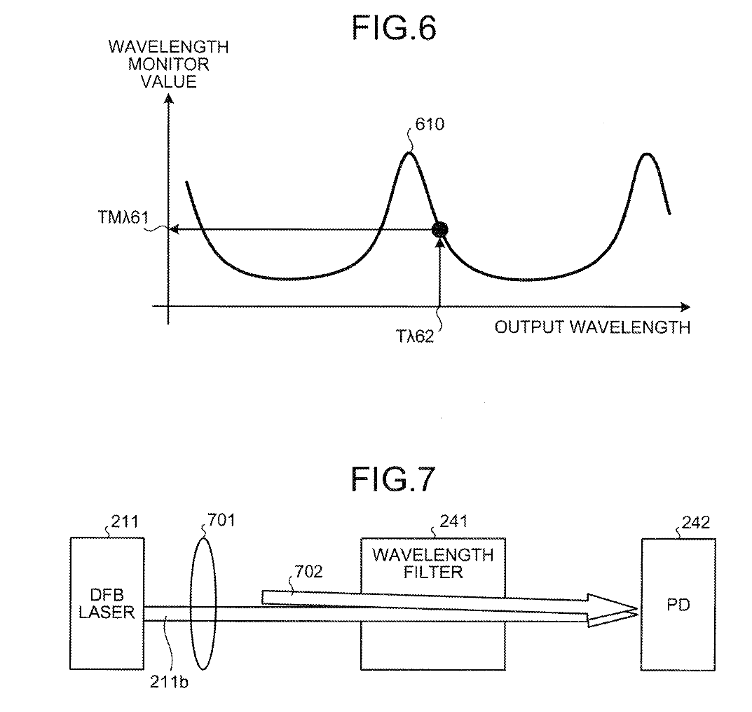

FIG. 6 is a graph of the characteristic of the wavelength monitor value with respect to the wavelength output by the DFB laser. In FIG. 6, the horizontal axis indicates the actual wavelength output by the DFB laser 211. The vertical axis indicates the wavelength monitor value output from the analog/digital converter 245. As indicated by a characteristic 610, the wavelength monitor value output from the analog/digital converter 245 has a characteristic of alternately repeating increases and decreases relative to the actual wavelength output by the DFB laser 211.

The light source apparatus 100 performs ATC at the start until the temperature monitor value comes closer to the target temperature and then switches ATC to AFC. This enables AFC to start from a state where the wavelength output by the DFB laser 211 is closer to a wavelength monitor target value TMλ61. Therefore, since the output wavelength is correlated one-to-one with the wavelength monitor value, even if the output value somewhat varies, the temperature of the DFB laser 211 is controllable in the appropriate increase and decrease directions. This enables the wavelength output by the DFB laser 211 to be maintained at a target wavelength TX 62.

FIG. 7 depicts light leaked to the wavelength filter. In FIG. 7, constituent elements identical to those depicted in FIG. 2 are given the same reference numerals used in FIG. 2 and will not be described. A lens 701 is a lens provided between the DFB laser 211 and the wavelength filter 241 to transmit the back light 211b output from the DFB laser 211. As depicted in FIG. 7, the back light 211b output from the DFB laser 211 is incident to the wavelength filter 241 orthogonally.

Leak light 702 is external light leaking into a metal case packaging the light source apparatus 100. The leak light 702 is incident to the wavelength filter 241 at an angle that is not orthogonal to the wavelength filter 241. In addition to the leak light 702, reflected light, etc., within the metal case packaging the light source apparatus 100 may be incident to the wavelength filter 241 at an angle not orthogonal to the wavelength filter 241.

Not only the back light 211b passing through the wavelength filter 241 but also the leak light 702, the reflected light, etc., passing through the wavelength filter 241 are incident on the light-receiving unit 242. Therefore, the current output from the light-receiving unit 242 is a current having an intensity obtained by combining the intensity of the back light 211b passing through the wavelength filter 241 and the intensity of the leak light 702, etc., passing through the wavelength filter 241.

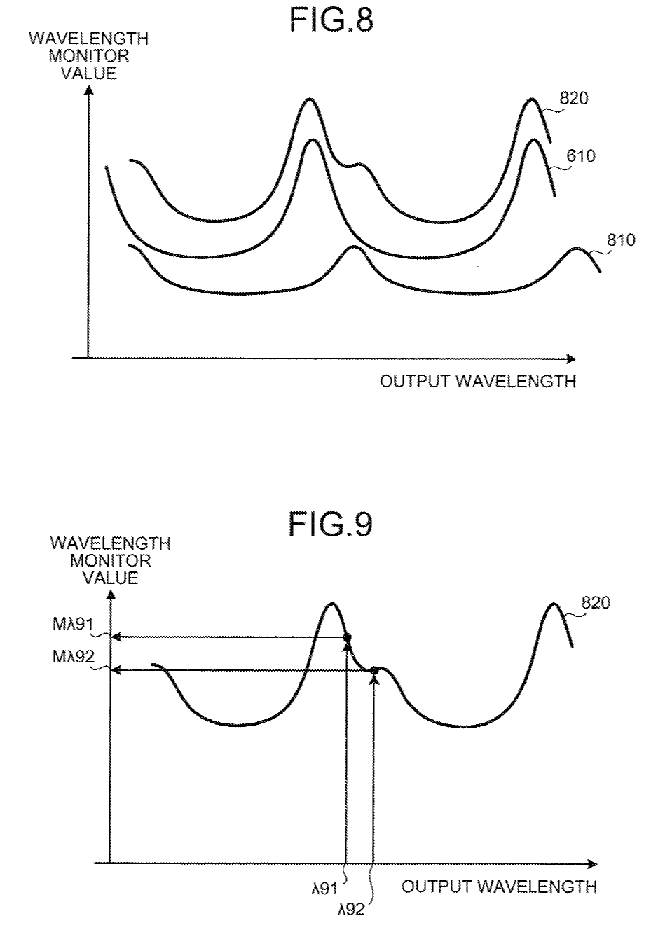

FIG. 8 is a graph of the characteristic of the wavelength monitor value when leak light is present. In FIG. 8, portions identical to those depicted in FIG. 6 are given the same reference numerals used in FIG. 6 and will not be described. A characteristic 810 indicates the characteristic of the wavelength monitor value for the wavelength of the leak light 702 depicted in FIG. 7. As depicted in FIG. 7, the back light 211b and the leak light 702 are incident on the wavelength filter 241 at angles different from each other. The transmission characteristic of the wavelength filter 241 is shifted in the wavelength direction (the horizontal direction of FIG. 8) due to the incident angle of the light to the wavelength filter 241.

Therefore, the characteristic 810 is shifted to the wavelength direction relative to the characteristic 610. The characteristic of the wavelength monitor value output from the analog/digital converter 245 is a combined characteristic 820 obtained by combining the characteristic 610 of the back light 211b and the characteristic 810 of the leak light 702. Since the characteristic 810 is shifted in the wavelength direction relative to the characteristic 610, the combined characteristic 820 obtained by combining the characteristic 610 and the characteristic 810 is a non-monotonic characteristic as compared to the characteristic 610 and the characteristic 810.

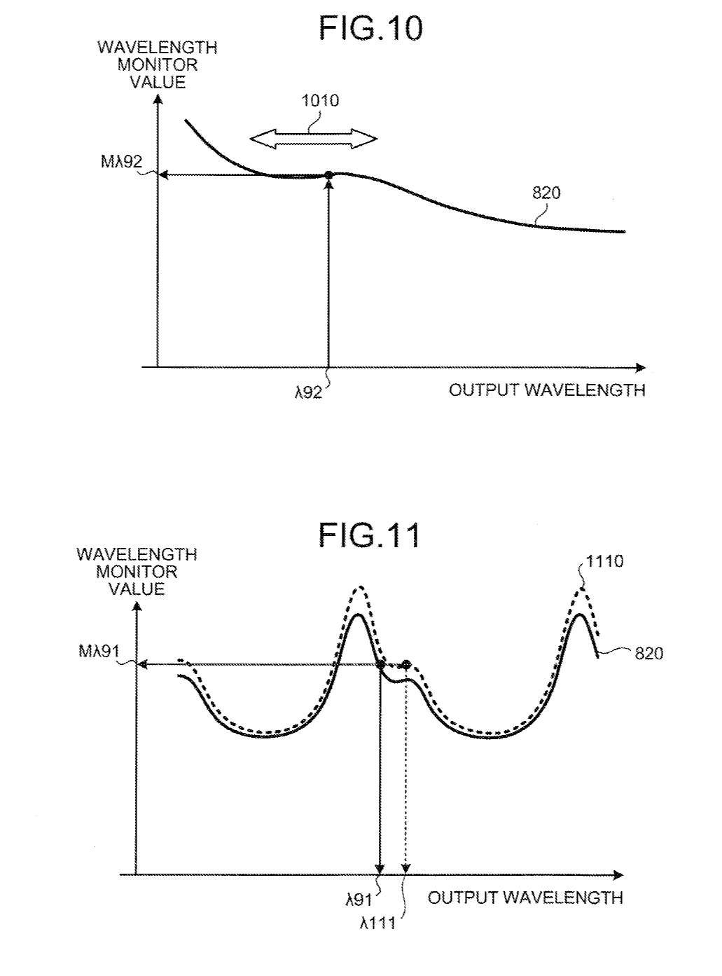

FIG. 9 is a graph of the combined characteristic depicted in FIG. 8. FIG. 10 is an enlarged graph of a portion of the combined characteristic depicted in FIG. 9. In FIGS. 9 and 10, portions identical to those depicted in FIG. 8 are given the same reference numerals used on FIG. 8 and will not be described. In FIG. 10, portions identical to those depicted in FIG. 9 are given the same reference numerals used in FIG. 9 and will not be described.

As depicted in FIG. 9, if the wavelength output by the DFB laser 211 is an output wavelength λ 91, a wavelength monitor value Mλ 91 varies in a monotonic portion of the combined characteristic 820. For example, the wavelength monitor value Mλ 91 monotonically decreases for the output wavelength λ 91. Thus, the variation in the output wavelength λ 91 of the DFB laser 211 is able to be monitored based on the wavelength monitor value Mλ 91.

On the other hand, as depicted in FIGS. 9 and 10, if the wavelength output by the DFB laser 211 is an output wavelength λ 92, a wavelength monitor value Mλ 92 varies in a flat portion of the combined characteristic 820 (within a range 1010). Thus, the wavelength monitor value Mλ 92 does not change substantially even if the output wavelength λ 92 of the DFB laser 211 varies. Thus, the variation in the output wavelength λ 92 of the DFB laser 211 is unable to be monitored based on the wavelength monitor value Mλ 92.

Therefore, if the wavelength output by the DFB laser 211 varies from the target wavelength, AFC is unable to adjust the wavelength output by the DFB laser 211 to the target wavelength. The variation in the wavelength output by the DFB laser 211 in this case is proportional to the response time constant of AFC and the wavelength variation of a few nm may occur in a few seconds. On the other hand, the light source apparatus 100 detects the variation in the wavelength output by the DFB laser 211 by monitoring the temperature monitor value while performing AFC.

FIG. 11 is a graph of the characteristic when the combined characteristic depicted in FIG. 9 varies as a result of aging. In FIG. 11, portions identical to those depicted in FIGS. 8 and 9 are given the same reference numerals used in FIGS. 8 and 9 and will not be described. It is assumed that the characteristic of the wavelength monitor value output from the analog/digital converter 245 is the combined characteristic 820 and the wavelength output by the DFB laser 211 is controlled to the output wavelength λ 91.

In this state, the wavelength monitor value Mλ 91 monotonically decreases for the output wavelength λ 91 and it is assumed that the combined characteristic 820 becomes a combined characteristic 1110 due to variations in ambient air temperature or variations associated with aging. This causes AFC to control the temperature of the DFB laser 211 such that the wavelength monitor value becomes the wavelength monitor value Mλ 91 and, as a result, the wavelength output by the DFB laser 211 becomes λ 111.

In this case, since the wavelength monitor value Mλ 91 is located in the flat portion of the combined characteristic 1110, the variation in the wavelength output by the DFB laser 211 is unable to be detected using the wavelength monitor value Mλ 91. Therefore, AFC is unable to return the wavelength output by the DFB laser 211 to the output wavelength λ 91. On the other hand, the light source apparatus 100 detects the variation in the wavelength output by the DFB laser 211 by monitoring the temperature monitor value while performing AFC.

According to the light source control device 120 according to the first embodiment, even if the characteristic of the wavelength monitor value for the wavelength output by the DFB laser 211 changes, the variation in the output wavelength is detected by monitoring the temperature of the DFB laser 211 while performing AFC. An abrupt variation in the wavelength output by the DFB laser 211 is prevented by stopping AFC if the temperature of the DFB laser 211 varies significantly.

For example, even if the incident angle of the back light 211b changes relative to the wavelength 241 or the angle, or the intensity of the leak light 702 or the reflected light in the metal casing changes, abrupt variations in the wavelength output by the DFB laser 211 are prevented and light having a stable wavelength is output. Therefore, communication using the light output by the DFB laser 211 is stabilized.

The stopping of AFC and issuance of an alarm, enables the user to take various measures such as safely terminating the system or replacing the apparatus. By stopping AFC to fix the drive current injected to the TEC 213, the temperature and the wavelength output by the DFB laser 211 are maintained substantially constant for a given period (e.g., several minutes to several hours). Therefore, the user is given time to take the various measures.

After AFC starts, the temperature variation determination by the control managing unit 260 is started after an error (wavelength error) between the wavelength monitor value and the wavelength monitor target value becomes equal to or less than a predetermined value. This prevents traditional variations in the temperature of the DFB laser 211 at the start of AFC from being wrongly detected as a wavelength variation of the DFB laser 211 resulting in a stopping of AFC even though no significant wavelength variation has occurred due to the wavelength filter 241, etc.

When the temperature of the DFB laser 211 is monitored while AFC is performed, temperature variations resulting from the wavelength variations of the DFB laser 211 must be differentiated from the temperature variations due to deterioration with age of the thermistor 211, etc. However, the response characteristic of the temperature variation due to the wavelength variation of the DFB laser 211 corresponds to the loop response characteristic of AFC and is on the order of a few seconds.

On the other hand, the deterioration with age occurs after several months to several years and the above temperature variations are easily differentiated by the cycle of the timer 261 outputting the trigger signal and the setting of the predetermined value in the determination circuit 264. If the temperature variation due to the wavelength variation of the DFB laser 211 is detected, AFC is stopped. If the temperature variation due to the deterioration with age of the thermistor 221, etc., is detected, AFC may be executed since AFC is not particularly affected or the user may be notified of the occurrence of the deterioration with age of the thermistor 221, etc.

If the temperature variation of the DFB laser 211 is detected and AFC is stopped, history information of this operation may be stored in a memory (such as the memory 262). Each time the light source apparatus 100 is activated, it is checked whether the history information has been stored in the memory and if the history information has been stored, the activation of the light source apparatus 100 is terminated. This may prevent the light source apparatus 100 from being activated while the wavelength output by the DFB laser 211 is varied.

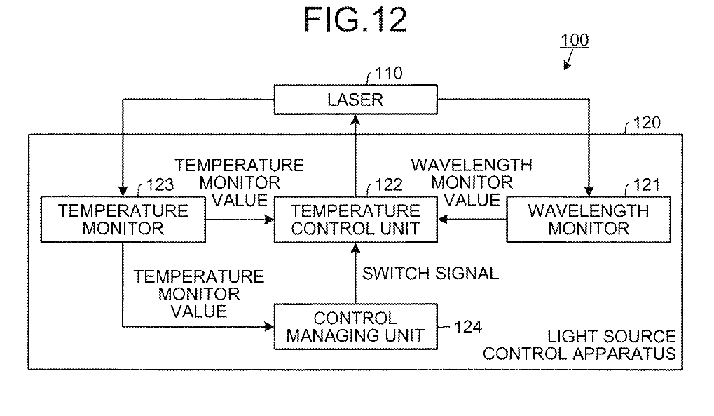

FIG. 12 is a block diagram of a light source apparatus according to a second embodiment. In FIG. 12, constituent elements identical to those depicted in FIG. 1 are given the same reference numerals used in FIG. 1 and will not be described. As depicted in FIG. 12, in the light source apparatus 100 according to the second embodiment, the temperature monitor 123 outputs the temperature monitor value to the temperature control unit 122 and the control managing unit 124.

The temperature control unit 122 switches and, performs AFC and constant-monitor-temperature control (AFC) that controls the temperature of the laser 100 such that the temperature monitor value output from the temperature monitor 123 becomes the target temperature monitor value. The temperature control unit 122 stops AFC to start ATC when the control managing unit 124 outputs a switch signal.

If a variation amount per unit time of the temperature monitor value output from the temperature monitor 123 exceeds a threshold value, the control managing unit 124 outputs to the temperature control unit 122, a switch signal to indicate that AFC should be switched to ATC. The control managing unit 124 may output the switch signal to the temperature control unit 122 and may update the target temperature monitor value of the temperature control unit 122 to the temperature monitor value before the variation amount per unit time of the temperature monitor value exceeds the threshold value.

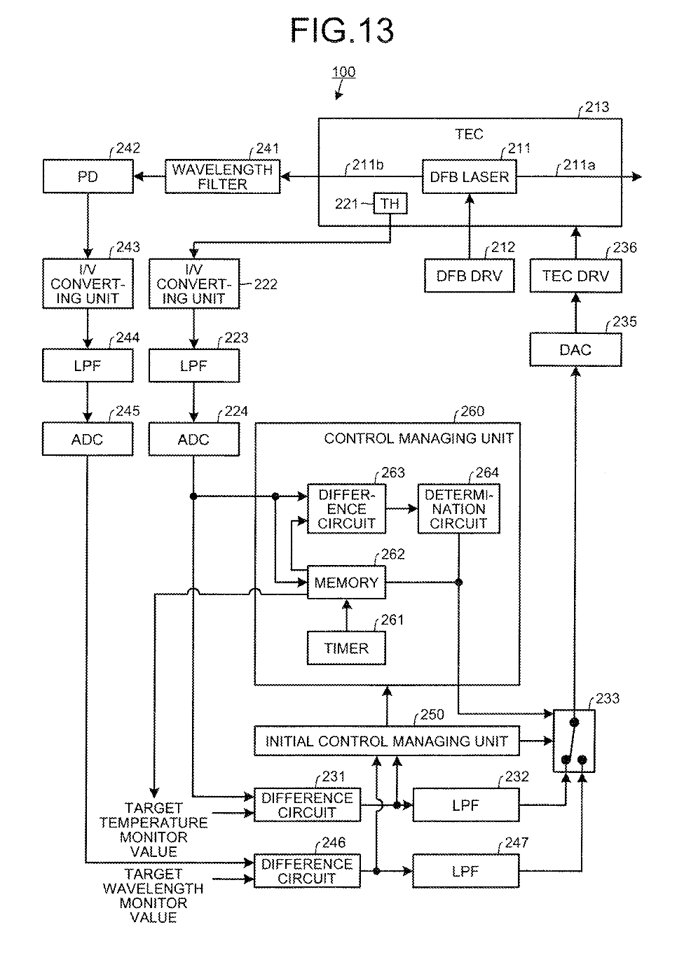

FIG. 13 is a block diagram of an example of the light source apparatus depicted in FIG. 12. As depicted in FIG. 13, the light source apparatus 100 according to the second embodiment (see FIG. 12) may have the configuration depicted in FIG. 2 omitting the switch 234.

The switch 233 outputs either the input temperature error or wavelength error to the digital/analogue converter 235 under the control of the control managing unit 260. If the control managing unit 260 outputs the switch signal while the wavelength error from the low-pass filter 247 is output to the digital/analogue converter 235, the switch 233 is switched to output the temperature error from the low-pass filter 232 to the digital/analogue converter 235.

If the temperature variation value output from the difference circuit 263 exceeds the threshold value, the determination circuit 264 outputs the switch signal to the switch 233 and the memory 262. This causes the signal output from the switch 233 to the digital/analogue converter 235 to be switched from the wavelength error to the temperature error. Thus, the temperature control of the DFB laser 211 is switched from AFC to ATC.

When the control managing unit 260 outputs the switch signal, the memory 262 outputs the temperature monitor value stored at this time. The temperature monitor value output from the memory 262 is set as a new target temperature monitor value input to the difference circuit 231. As a result, AFC is switched to ATC and the target temperature of ATC is updated.

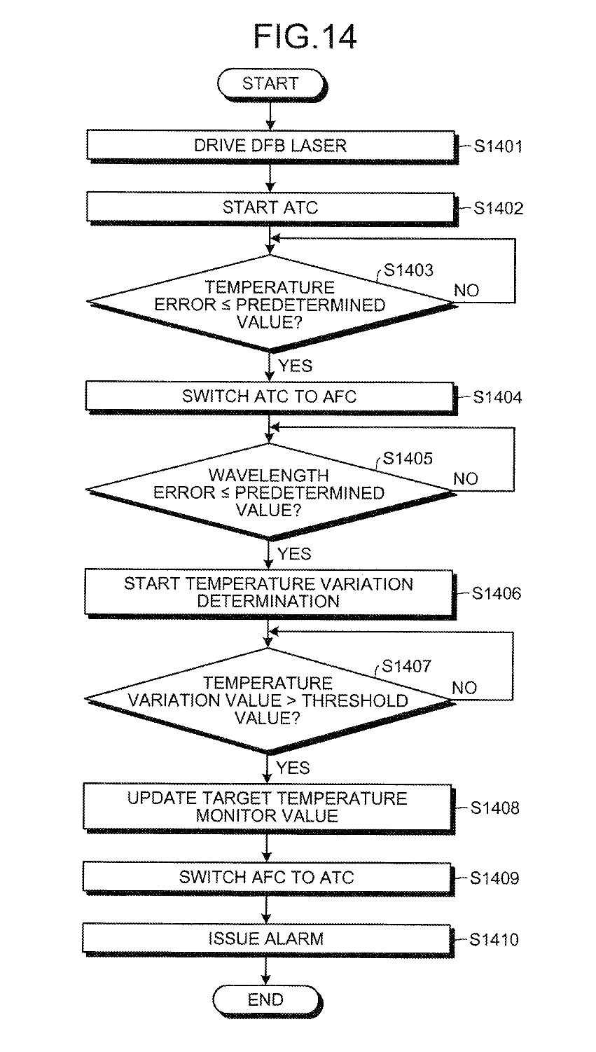

FIG. 14 is a flowchart of an example of the operation of the light source apparatus depicted in FIG. 13. Steps S1401 to S1407 depicted in FIG. 14 are identical to steps S301 to S307 depicted in FIG. 3 and will not be described. If the temperature variation value exceeds the threshold value at step S1407 (step S1407: YES), the target temperature monitor value input to the difference circuit 231 is updated to the temperature monitor value stored in the memory 262 (step S1408).

The determination circuit 264 outputs the switch signal to the switch 233 to switch the temperature control of the DFB 211 from AFC to ATC (step S1409). The determination circuit 264 issues an alarm externally (step S1410), and a series of processing is terminated. Step S1408 may be skipped.

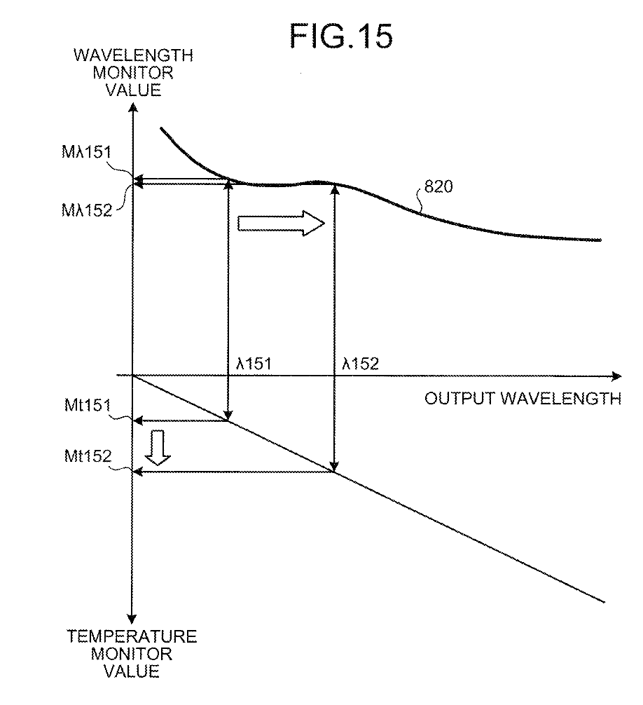

FIG. 15 is a graph of the switchover from AFC to ATC. In FIG. 15, portions identical to those depicted in FIG. 10 are given the same reference numerals used in FIG. 10 and will not be described. It is assumed that the characteristic of the wavelength monitor value output from the analog/digital converter 245 becomes the combined characteristic 820 due to an abnormality such as a change in the incident angle of the back light 211b to the wavelength filter 241, a change in the angle or the intensity of the leak light 702 and the reflected light in the metal casing, etc.

It is also assumed that the temperature of the DFB laser 211 changes in response to a malfunction of AFC and that the actual wavelength output by the DFB laser 211 varies from λ 151 to λ 152. In this case, if the wavelength output by the DFB laser 211 varies from ═ 151 to λ 152, since the value of the wavelength monitor value does not change substantially (from a wavelength monitor value Mλ 151 to a wavelength monitor value Mλ 152), the variation in the output wavelength is unable to be detected using the wavelength monitor value.

On the other hand, the temperature monitor value output from the analog/digital converter 224 monotonically changes relative to the actual temperature of the DFB laser 211 (see the characteristic 510 of FIG. 5). Since the wavelength output by the DFB laser 211 is proportional to the temperature of the DFB laser 211, the temperature monitor value consistently monotonically changes relative to the wavelength output by the DFB laser 211.

Thus, the variation in the wavelength output by the DFB laser 211 (from λ 151 to λ 152) due to malfunction of AFC is detected by monitoring the variation in the temperature monitor value (from a temperature monitor value Mt 151 to a temperature monitor value Mt 152) along with AFC. If the variation in the wavelength output by the DFB laser 211 is detected, the temperature control of the DFB laser 211 is able to be switched from AFC to ATC to stabilize the wavelength output by the DFB laser 211.

The target temperature monitor value of ATC may be updated to the temperature monitor value stored in the memory 262. As a result, the temperature of the DFB laser 211 is controlled to the temperature immediately before the variation in the wavelength output by the DFB laser 211. Therefore, even if the characteristic of the temperature monitor value changes due to deterioration with age (see, e.g., the characteristic 510 of FIG. 5 and the dotted-line 511), the wavelength output by the DFB laser 211 may be controlled to the target wavelength from the start of the light source apparatus 100 until a variation in the output wavelength occurs.

According to the light source control device 120 according to the second embodiment, the effect of the light source control device 120 according to the first embodiment is achieved and AFC is switched to ATC if the temperature of the DFB laser 211 varies significantly. Thus, the wavelength output by the DFB laser 211 is continuously maintained at the target value by ATC.

If the temperature control of the DFB laser 211 by ATC subsequently continues, the temperature and the wavelength output by the DFB laser 211 gradually shift from the target values due to deterioration with age (see FIG. 5). However, since the variations of the temperature and the wavelength output by the DFB laser 211 due to deterioration with age are very slow, the wavelength output by the DFB laser 211 is kept nearly constant for a long period (e.g., several months). Therefore, the user is given sufficient time to take various measures.

The temperature monitor value that is stored is a value before the variation amount per unit time of the temperature monitor value exceeds the threshold value, and the target temperature monitor value of the temperature control unit 122 is updated to the stored temperature monitor value when AFC is switched to ATC. Therefore, even if the characteristic of the temperature monitor value changes due to deterioration with age, the wavelength output by the DFB laser 211 is kept nearly constant from the start of the light source apparatus 100 until a variation in the output wavelength occurs.

The memory 262 sequentially storing the temperature monitor value for detecting an abrupt temperature variation in the DFB laser 211 is used as a storage unit that stores the temperature monitor value before the variation amount per unit time of the temperature monitor value exceeds the threshold value. Thus, the target temperature monitor value of the temperature control unit 122 may be updated without particularly providing a storage unit for storing the temperature monitor value before the variation amount per unit time of the temperature monitor value exceeds the threshold value.

As described, according to the light source control device 120, the light source apparatus 100, and the wavelength control method disclosed, communication is stabilized even when the characteristic of the wavelength monitor value for the wavelength output by the DFB laser 211 changes. Although a configuration using the DFB laser 211 as the laser 110 has been described in the above embodiments, the laser 110 is not limited to the DFB laser 211 and may be any laser whose output wavelength is temperature dependent.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A light source control apparatus of a light source apparatus comprising:
a laser having a wavelength that varies depending on temperature;
a wavelength monitor that monitors the wavelength of light output from the laser;
a temperature controller that controls the temperature of the laser based on an output of the wavelength monitor;
a temperature monitor that monitors the temperature of the laser; and
a control manager that stops control by the temperature controller if a variation amount per unit time of the temperature monitored by the temperature monitor exceeds a threshold value.

2. The light source control apparatus according to claim 1, wherein
the temperature controller controls the temperature of the laser by adjusting a drive current injected into a thermoelectric cooling device provided on the laser, and
the temperature controller fixes the drive current injected into the thermoelectric cooling device, if the control manager stops the control by the temperature controller.

3. The light source control apparatus according to claim 1, wherein
the control manager stops the control by the temperature controller if after an error of the wavelength monitored by the wavelength monitor becomes equal to or less than a predetermined value, the variation amount exceeds the threshold value.

4. The light source control apparatus according to claim 1, wherein
the temperature controller, under the control of the control manager, switches between and executes constant-monitor-wavelength control of controlling the temperature of the laser based on the output of the wavelength monitor and constant-monitor-temperature control of controlling the temperature of the laser such that the temperature monitored by the temperature monitor becomes a target temperature monitor value, and
the control manager switches the control of the temperature controller from the constant-monitor-wavelength control to the constant-monitor-temperature control, if the variation amount exceeds the threshold value.

5. The light source control apparatus according to claim 4, further comprising
an initial control manager that switches control by the temperature controller to the constant-monitor-temperature control at startup of the light source apparatus, and switches control by the temperature controller to the constant-monitor-wavelength control when an difference between the temperature monitored by the temperature monitor and the target temperature monitor value becomes equal to or less than a predetermined value.

6. The light source control apparatus according to claim 4, further comprising
a storage unit that stores the temperature monitored by the temperature monitor before the variation amount exceeds the threshold value, wherein
the control manager updates the target temperature monitor value of the temperature controller to the temperature stored in the storage unit, if the variation amount exceeds the threshold value.

7. The light source control apparatus according to claim 6, wherein
the storage unit sequentially stores the temperature monitored by the temperature monitor, and
the control manager calculates the variation amount based on a difference between a temperature newly monitored by the temperature monitor and a temperature stored by the storage unit.

8. The light source control apparatus according to claim 1, wherein
the control manager issues an alarm indicating that a variation in the wavelength of the laser has been detected, if the variation amount exceeds the threshold value.

9. The light source control apparatus according to claim 1, wherein
the control manager shuts down the light source apparatus when a given period of time elapses after the variation amount exceeds the threshold value.

10. A light source apparatus comprising:
a laser having a wavelength that varies depending on temperature;
a wavelength monitor that monitors the wavelength of light output from the laser;
a temperature controller that controls the temperature of the laser such that the wavelength monitored by the wavelength monitor becomes a target wavelength monitor value;
a temperature monitor that monitors the temperature of the laser; and
a control manager that stops constant-monitor-wavelength control by the temperature controller if a variation amount per unit time of the temperature monitored by the temperature monitor exceeds a threshold value.

11. A light source control method of a laser having a wavelength that varies depending on temperature, the light source control method comprising:
monitoring the wavelength of light output from the laser;
controlling the temperature of the laser based on an output at the monitoring of the wavelength;
monitoring the temperature of the laser; and
managing control by stopping constant-monitor-wavelength control at the controlling of the temperature, if a variation amount per unit time of the temperature monitored at the monitoring of the temperature exceeds a threshold value.
